(19) United States
(12) Patent Application Publication
(10) Pub. No.: US 2026/0016842 A1
(43) Pub. Date: Jan. 15, 2026

(54) SYSTEMS AND METHODS FOR CONTROLLING FLUID-FLOW NETWORK TRANSPORT INFRASTRUCTURE USING CONNECTED FIELD DEVICES

(71) Applicant: Xylem Vue Inc., White Plains, NY (US)

(72) Inventor: Ruben Kertesz, Zionsville, IN (US)

(21) Appl. No.: 19/268,449

(22) Filed: Jul. 14, 2025

Related U.S. Application Data
(60) Provisional application No. 63/671,475, filed on Jul. 15, 2024.

(51) Int. Cl. G05D 7/06; E03F 7/00; G05B 13/02

(52) U.S. Cl. CPC G05D 7/0623; E03F 7/00; G05B 13/0265; E03F 2201/20

(57) ABSTRACT

Systems and methods are disclosed for controlling a fluid-flow network transport infrastructure using distributed field devices. A control system applies a fluid-flow control policy to configure operational modes for a plurality of field devices. Each field device is configured to monitor fluid-flow parameters and report sensor data based on dynamic criteria. Upon receiving an alert from a field device, the system identifies other field devices that are hydrologically or hydraulically connected to the alerting device and satisfy a defined proximity threshold. Activation commands are issued to prompt additional data collection. The system manages fluid-flow control devices, such as valves or pumps, based at least in part on received sensor data, policy criteria, and environmental inputs. A simulated digital counterpart can model expected system behavior and inform adaptive policy adjustment. The disclosed architecture supports condition-responsive monitoring and decentralized control, reducing energy consumption and enhancing real-time responsiveness.

### RELATED APPLICATIONS

Any and all applications for which a foreign or domestic priority claim is identified in the Application Data Sheet as filed with the present application are incorporated by reference under 37 CFR 1.57 and made a part of this specification. This application claims priority to U.S. Provisional Patent Application No. 63/671,475, entitled “Systems and Methods for Controlling Fluid-Flow Network Transport Infrastructure Using Connected Field Devices,” filed Jul. 15, 2024, which is hereby incorporated by reference

### FIELD

The present disclosure generally relates to the field of fluid-flow network transport infrastructure management and monitoring, and more particularly, to a dynamic and energy-efficient system for monitoring and control of fluid-flow network transport infrastructure, such as sewer networks.

### BACKGROUND

Sewer network management is a critical aspect of public utility infrastructure, particularly in urban settings. These systems, comprised of an intricate collection of pipelines, pumps, valves, and other control structures which work to direct wastewater and/or stormwater from various sources in sewersheds (e.g. residential and commercial buildings) to appropriate treatment facilities.

In many instances, the monitoring and control of these complex networks is accomplished via Supervisory Control and Data Acquisition (SCADA) systems. The SCADA systems involve a network of devices, which collect data from various sensors deployed throughout the field. This data is then processed by a central system, giving operators real-time information about the status of the network and allowing them to make necessary adjustments.

The SCADA networks often operate on a constant communication basis, with each device regularly sending updates to the central system and to each other. This continuous communication, however, often leads to high energy consumption due to the requirement for a continuous power supply to maintain the data acquisition devices and remote terminal units, in addition to network infrastructure.

Traditional SCADA systems typically function under set parameters and are not designed to adapt to fluctuating conditions. During periods of increased rainfall, for example, the volume of water within the sewer network can rise dramatically, presenting a higher risk of overflows. However, SCADA systems generally must be carefully designed and programmed at the onset to handle these rapid changes efficiently due to their lack of dynamic parameter adjustment, requiring significant foresight and a deep understanding of the fluid transport system to realize significant dynamic control as well as complicated programming logic to federate control execution on multiple logic controllers.

Further, the implementation of SCADA systems often poses considerable logistical challenges, such as the need for a reliable power supply, the establishment of a secure wired or wireless communication network, and the coordination of complex integration logistics. These barriers may deter utility operators from deploying automated control systems across their networks.

Moreover, conventional SCADA systems often do not fully incorporate the potential of current data analytics and machine learning methodologies. For instance, advanced analytics, while capable of enhancing the functionality and insights derived from such systems, are typically added as supplementary components and may not be organically integrated into the existing infrastructure. As such, the existing systems for sewer network management have certain limitations that can affect their efficiency and adaptability.

### SUMMARY

Disclosed herein is a system for enhanced fluid-flow network transport infrastructure management. A system can utilize a network of independently deployable field devices equipped with sensors to monitor various fluid-flow parameters within the infrastructure. By establishing communication with these field devices, the system can collect data on fluid-flow. The system can implement a fluid-flow control policy that defines operational criteria for the plurality of field devices and control criteria for managing fluid-flow control devices. When sensor data from a particular field device satisfies a condition, the system can identify a subset of field devices that are hydrologically or hydraulically connected to the particular field device, and within a defined proximity. Activation commands can be transmitted to enable these devices to transmit their respective sensor data. The system can manage the fluid-flow control devices based on the received data and the fluid-flow control policy.

Certain illustrative examples are described in the following numbered clauses:

Clause 1. A method for controlling a fluid-flow network transport infrastructure, the method comprising:
establishing communication with a plurality of field devices, wherein each field device comprises a sensor configured to monitor a parameter related to fluid-flow within the fluid-flow network transport infrastructure;
obtaining environmental data associated with the fluid-flow network transport infrastructure;
applying a fluid-flow control policy to adjust an operational mode of the plurality of field devices to a designated mode based at least in part on the environmental data, wherein the fluid-flow control policy comprises operational criteria for the plurality of field devices and control criteria for managing one or more fluid-flow control devices based on modeled or real-time system conditions;
receiving an alert from a first field device of the plurality of field devices, wherein the alert indicates that sensor data from the first field device satisfies a threshold associated with the designated mode;
identifying, based on a network topology of the plurality of field devices, a set of field devices that are hydrologically or hydraulically connected to the first field device and satisfy a defined proximity threshold, wherein the defined proximity threshold is based at least in part on flow path characteristics, topological separation, or modeled influence zones;
transmitting an activation command to the set of field devices to cause the set of field devices to transmit respective sensor data; and
managing the one or more fluid-flow control devices according to the fluid-flow control policy based on the respective sensor data.

Clause 2. The method of Clause 1, wherein identifying the set of field devices comprises:
evaluating the network topology using a representation of physical and logical infrastructure relationships to determine candidate field devices that are hydrologically or hydraulically connected to the first field device; and
selecting the set of field devices based at least in part on the defined proximity threshold specified in the fluid-flow control policy, wherein the defined proximity threshold reflects one or more of hydraulic travel time, number of downstream junctions, modeled flow propagation, or inferred influence regions from a simulated digital counterpart.

Clause 3. The method of any of the preceding clause, wherein each field device of the plurality of field devices is configured to monitor the parameter at a first monitoring frequency and report the sensor data at a second reporting frequency that is lower than the first monitoring frequency, and wherein the first monitoring frequency is adjusted locally by the field device based on internal diagnostics, environmental conditions, or policy-defined operational criteria.

Clause 4. The method of any of the preceding clause, further comprising:
in response to receiving the alert and activating the set of field devices, determining that one or more additional field devices not included in the set also satisfy the defined proximity threshold based on updated sensor data or flow modeling; and
transmitting a secondary activation command to the one or more additional field devices to obtain further sensor data for use in managing the fluid-flow control devices.

Clause 5. The method of any of the preceding clause, wherein the fluid-flow control policy indicates an operational schedule for the plurality of field devices, wherein the operational schedule specifies a frequency at which the plurality of field devices transmit sensor data.

Clause 6. The method of any of the preceding clause, wherein each field device of the plurality of field devices communicates sensor data at a frequency defined by the fluid-flow control policy and locally monitors the respective parameter at a more frequent frequency.

Clause 7. The method of any of the preceding clause, wherein the fluid-flow control policy includes a policy-driven decision-making module that determines the designated mode and the operational criteria for the plurality of field devices based on the environmental data, historical data, or system constraints.

Clause 8. The method of any of the preceding clause, wherein the fluid-flow control policy includes a machine learning algorithm that continuously adapts and optimizes the operational mode and control criteria for the plurality of field devices based on observed system behavior and performance.

Clause 9. The method of any of the preceding clause, wherein the activation command transmitted to the set of field devices includes instructions for adjusting a reporting frequency of the respective sensor data.

Clause 10. The method of any of the preceding clause, wherein the fluid-flow control policy includes adaptive control criteria that dynamically adjusts the operational criteria for the plurality of field devices based on real-time data, system demands, and performance objectives.

Clause 11. The method of any of the preceding clause, wherein the managing of the fluid-flow control devices comprises dynamically adjusting control settings, wherein the control settings include valve positions, pump speeds, or flow rates.

Clause 12. The method of any of the preceding clause, further comprising:
inputting the sensor data received from the plurality of field devices into a trained machine-learned model configured to analyze the sensor data and generate one or more policy adjustment outputs, wherein the policy adjustment outputs modify the fluid-flow control policy by adjusting at least one of the operational criteria for the plurality of field devices, threshold conditions for alert generation, control settings for fluid-flow control devices, or reporting frequency of the sensor data; and
applying the modified fluid-flow control policy to dynamically regulate fluid-flow within the fluid-flow network transport infrastructure based at least in part on the policy adjustment outputs.

Clause 13. The method of any of the preceding clause, wherein the proximity threshold is satisfied when a particular field device is located within a predetermined distance, within a predetermined number of junctions, or downstream by a predetermined flow distance from the first field device in the fluid-flow network transport infrastructure.

Clause 14. The method of any of the preceding clause, wherein the network topology of the plurality of field devices encompasses a representation of a physical layout of the fluid-flow network transport infrastructure, the representation indicating a spatial arrangement of pipes, junctions, and field device locations, the representation indicating hydraulic connections between the field devices indicating flow paths, interconnections, or dependencies within the fluid-flow network transport infrastructure, and the representation indicating hydrological relationships between the field devices reflecting drainage patterns, water flow directions, or catchment areas of the fluid-flow network transport infrastructure.

Clause 15. A system for controlling a fluid-flow network transport infrastructure, the system comprising:
a control system comprising one or more processors and memory storing instructions that, when executed by the one or more processors, cause the control system to:
establish communication with a plurality of field devices, each field device comprising at least one sensor configured to monitor a parameter related to fluid-flow within the fluid-flow network transport infrastructure and a communication interface configured to transmit sensor data;
obtain environmental data associated with the fluid-flow network transport infrastructure;
apply a fluid-flow control policy to adjust an operational mode of the plurality of field devices to a designated mode based at least in part on the environmental data, wherein the fluid-flow control policy comprises operational criteria for the plurality of field devices and control criteria for managing one or more fluid-flow control devices based on modeled or real-time system conditions, wherein the one or more fluid-flow control devices are configured to regulate fluid-flow within the fluid-flow network transport infrastructure;
receive an alert from a first field device of the plurality of field devices, wherein the alert indicates that sensor data from the first field device satisfies a threshold associated with the designated mode;
identify, based on a network topology of the plurality of field devices, a set of field devices that are hydrologically or hydraulically connected to the first field device and satisfy a defined proximity threshold, wherein the defined proximity threshold is based at least in part on flow path characteristics, topological separation, or modeled influence zones;
transmit an activation command to the set of field devices to cause the set of field devices to transmit respective sensor data; and
manage the one or more fluid-flow control devices according to the fluid-flow control policy based on the respective sensor data.

Clause 16. The system of any of the preceding clause, wherein the control system is further configured to identify the set of field devices by evaluating the network topology using a representation of physical and logical infrastructure relationships to determine candidate field devices that are hydrologically or hydraulically connected to the first field device, and selecting the set of field devices based at least in part on the defined proximity threshold specified in the fluid-flow control policy, wherein the defined proximity threshold reflects one or more of hydraulic travel time, number of downstream junctions, modeled flow propagation, or inferred influence regions from a simulated digital counterpart.

Clause 17. The system of any of the preceding clause, wherein each field device is further configured to monitor the parameter at a first monitoring frequency and report the sensor data at a second reporting frequency that is lower than the first monitoring frequency, and wherein the first monitoring frequency is locally adjusted by the field device based on internal diagnostics, environmental conditions, or policy-defined operational criteria.

Clause 18. The system of any of the preceding clause, wherein the control system is further configured to, in response to receiving the alert and activating the set of field devices, determine that one or more additional field devices not included in the set also satisfy the defined proximity threshold based on updated sensor data or flow modeling, and transmit a secondary activation command to the one or more additional field devices to obtain additional sensor data for use in managing the one or more fluid-flow control devices.

Clause 19. A non-transitory computer-readable medium storing instructions that, when executed by one or more processors of a control system, cause the control system to perform operations comprising:
establishing communication with a plurality of field devices, wherein each field device comprises a sensor configured to monitor a parameter related to fluid-flow within the fluid-flow network transport infrastructure;
obtaining environmental data associated with the fluid-flow network transport infrastructure;
applying a fluid-flow control policy to adjust an operational mode of the plurality of field devices to a designated mode based at least in part on the environmental data, wherein the fluid-flow control policy comprises operational criteria for the plurality of field devices and control criteria for managing one or more fluid-flow control devices based on modeled or real-time system conditions;
receiving an alert from a first field device of the plurality of field devices, wherein the alert indicates that sensor data from the first field device satisfies a threshold associated with the designated mode;
identifying, based on a network topology of the plurality of field devices, a set of field devices that are hydrologically or hydraulically connected to the first field device and satisfy a defined proximity threshold, wherein the defined proximity threshold is based at least in part on flow path characteristics, topological separation, or modeled influence zones;
transmitting an activation command to the set of field devices to cause the set of field devices to transmit respective sensor data; and
managing the one or more fluid-flow control devices according to the fluid-flow control policy based on the respective sensor data.

Clause 20. The non-transitory computer-readable medium of Clause 19, wherein the instructions further cause the control system to:
configure each field device to monitor the parameter at a first monitoring frequency and report the sensor data at a second reporting frequency that is lower than the first monitoring frequency; and
adjust the first monitoring frequency locally at each field device based at least in part on internal diagnostics, environmental conditions, or policy-defined operational criteria.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 is a block diagram illustrating an example of a fluid-flow network transport infrastructure.

FIG. 2 illustrates a diagram of an example fluid-flow network transport infrastructure.

FIG. 3 is a flow diagram illustrating an example routine for controlling a fluid-flow network transport infrastructure.

FIG. 4 illustrates example communication topologies for coordinating field devices in a fluid-flow network transport infrastructure.

### DETAILED DESCRIPTION

Fluid-flow network transport infrastructure, such as sewer systems, stormwater conveyance systems, or combined drainage systems, often includes spatially distributed assets and operates under variable flow conditions. Traditional control architectures, including SCADA-based systems, rely on continuous communication links or fixed control logic to manage sensors and actuators throughout the network. These systems may involve high power consumption, limited adaptability, or significant integration complexity, particularly when deployed at scale or in areas without persistent power or network connectivity. The challenges can be compounded by fluid-flow variability, such as that introduced by rainfall events, blockages, or treatment capacity constraints, which may require real-time situational awareness and responsive control to avoid overflow, underutilization, or structural stress.

Some inventive concepts described herein relate to a control architecture configured to enable decentralized, policy-driven management of fluid-flow transport infrastructure. A plurality of field devices can be configured to operate in a low-power mode and transition to an active state in response to local threshold conditions and/or remote activation commands. The system can implement a fluid-flow control policy that defines operational criteria for field devices or control criteria for fluid-flow control devices. When sensor data from a field device satisfies a condition, the system can identify a set of field devices that are hydrologically or hydraulically connected to the alerting device and located within a defined proximity threshold. Activation commands can be issued to the identified set, prompting transmission of additional sensor data. This responsive activation model can enable scalable sensing with reduced energy consumption or communication overhead.

Some inventive concepts described herein relate to a coordination entity (e.g., referred to as a fluid-flow coordinator) configured to execute control logic in accordance with the fluid-flow control policy. The fluid-flow coordinator can receive alert signals, identify related field devices based on topological or hydraulic connectivity, and/or orchestrate additional data acquisition or control actions. Based at least in part on the received sensor data, the fluid-flow coordinator can manage one or more fluid-flow control devices, such as valves, pumps, weirs, or flow regulators, to achieve one or more operational objectives. These objectives can include, but are not limited to, overflow mitigation, energy conservation, treatment capacity balancing, or compliance with regulatory constraints.

Some inventive concepts described herein relate to a simulated digital counterpart (sometimes referred to as a digital twin) configured to model or simulate fluid-flow behavior across the infrastructure. In some cases, the digital twin can infer unmeasured conditions based on observed data, known topology, or historical patterns. During periods of low activity or dry weather, the digital twin can provide data infill or simulate expected system states, reducing the need for active data transmission from the field. In some cases, the digital twin can validate anomalies or trigger additional measurements to resolve uncertainty in the physical system state. The digital twin can inform adjustments to the fluid-flow control policy through predictive analytics or recursive learning processes.

In some cases, the described architecture can be implemented using distributed hardware devices configured for independent operation and/or asynchronous communication. The disclosed approach can enable condition-responsive control without requiring continuous telemetry, fixed polling intervals, or centralized computation. Field devices can operate independently or under the direction of the fluid-flow coordinator, while in some cases the digital twin can provide continuous context or policy refinement in the background.

In light of the description provided herein, the disclosed subject matter can be understood as providing an improvement to fluid-flow infrastructure control. The disclosed systems or methods can reduce energy consumption, improve responsiveness to transient events, and/or enhance operational resilience. The architecture can support deployment in existing infrastructure or new installations and can interoperate with conventional SCADA systems or function independently in limited-connectivity environments.

Some aspects of the inventive concepts described herein relate to a system architecture that incorporates a combination of distributed sensing, coordination logic, and simulation-based modeling to manage fluid-flow network transport infrastructure. In some cases, the system includes a plurality of field devices configured to monitor localized conditions and provide sensor data based at least in part on policy-defined reporting thresholds or activation criteria. The system can include one or more coordination components configured to evaluate network topology or fluid-flow relationships and apply a control policy to manage fluid-flow control devices in response to observed or inferred conditions. A simulation component, in some cases, maintains a modeled representation of the infrastructure and can supplement observed data, detect deviations, or inform ongoing policy adjustment.

The respective components of the system can operate in a distributed or cooperative manner, based at least in part on prevailing network conditions, environmental inputs, or infrastructure configuration. Monitoring behavior, control actions, or model-driven evaluations can be performed independently or in coordination, and the specific logic applied can vary across different segments of the infrastructure. This architecture supports adaptive monitoring or control behavior that does not rely on fixed reporting intervals or static logic structures, allowing fluid-flow infrastructure to respond to spatial or temporal variability using condition-specific responses grounded in local measurement, hydraulic context, or predictive modeling.

### Example Infrastructure

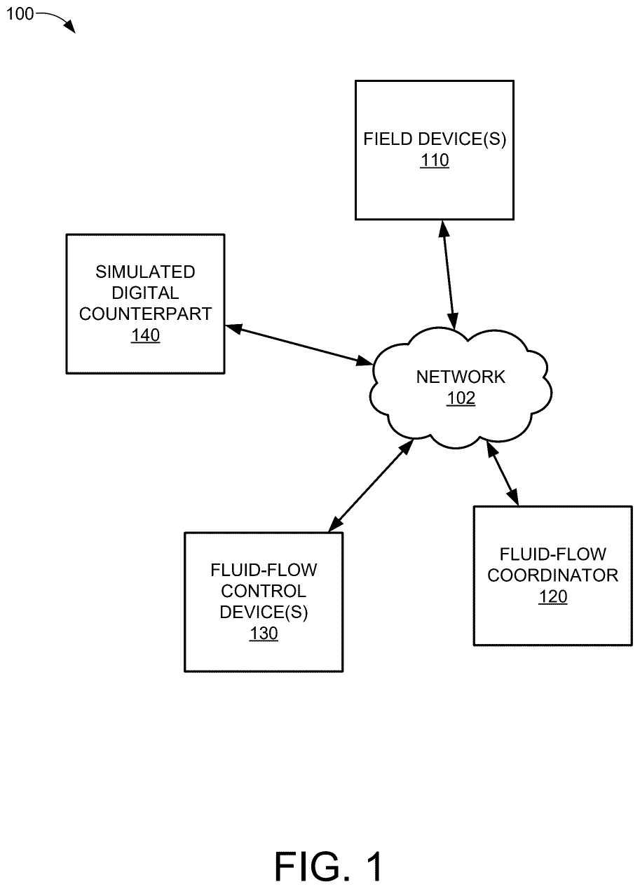

FIG. 1 is a block diagram illustrating an example of a fluid-flow network transport infrastructure 100. The fluid-flow network transport infrastructure 100 includes one or more field devices 110 (referred to individually or collectively as field device(s) 110), a fluid-flow coordinator 120, one or more fluid-flow control devices 130 (referred to individually or collectively as fluid-flow control device(s) 130), and/or a simulated digital counterpart 140. It will be appreciated that the number of devices or systems in fluid-flow network transport infrastructure 100 can vary across embodiments. For instance, the fluid-flow network transport infrastructure 100 can incorporate multiple field devices 110, ranging from a few to tens, hundreds, or thousands. Similarly, the fluid-flow network transport infrastructure 100 can include multiple fluid-flow control devices 130, which may vary in number from a few to tens, hundreds, or thousands.

The field devices 110, the fluid-flow coordinator 120, and/or the fluid-flow control devices 130 may communicate with one another within the fluid-flow network transport infrastructure 100 via a network 102. The network 102, although represented as a single, unified network, can include multiple distinct or distributed networks. For instance, a fluid-flow control device 130 might communicate with the fluid-flow coordinator 120 via a different network from the one that the fluid-flow coordinator 120 uses to communicate with a field device 110. The network 102 can incorporate various forms of communication networks, including, but not limited to, local area networks (LANs), wide area networks (WANs), cellular networks, long-range wireless technologies, short-range wireless technologies (e.g., Bluetooth), Wi-Fi networks, satellite networks, or wired networks (e.g., Ethernet or fiber optic), or a combination thereof.

The field devices 110 can be configured for integration into a wide array of fluid-flow network transport infrastructures 100, thereby enhancing the flexibility and applicability of the system. These infrastructures may include, but are not limited to, sewer systems, agricultural systems, stormwater systems, water distribution networks, or oil and gas pipelines, each of which can include their own unique structural layouts, operational parameters, or functional requirements.

One or more field devices 110 may be strategically positioned throughout the fluid-flow network transport infrastructure 100. For example, a field device 110 can be placed at any location of interest within the fluid-flow network transport infrastructure 100, such as junctions (e.g., manholes, in the case of sewers), pipeline intersections, reservoir entry points, or along major transport arteries. As an example, in a sewer system, field devices 110 may be placed at manholes in flood-prone zones, at CSO (combined sewer overflow) structures, or downstream of industrial inflows to monitor high-risk discharge points.

Each field device 110 can include one or more sensors for monitoring one or more fluid-flow parameters, site-condition parameters, or operational parameters. Example fluid-flow parameters include, but are not limited to, fluid velocity, fluid level, fluid-flow rate, fluid-flow regime, temperature, hydrogen sulfide, and water quality indicators such as pH, dissolved oxygen, turbidity, conductivity, and chemical or biological constituents. Example site condition parameters include, but are not limited to, humidity, air temperature, pressure, hydrogen sulfide (gas), observations such as water ingress through cracks or joints, presence of oil, trash or debris in conveyance infrastructure, etc. Operational parameters can be dependent on the equipment deployed for system control; some examples include, but are not limited to, impeller rotation and pump speed, motor vibration, acoustic signature, and temperature, valve position and vibration, gate elevation, bladder pressure, manhole lid position, etc. These sensors can enable real-time or near-real-time tracking of fluid dynamics, environmental conditions, potential pollutant concentrations, or system operation, contributing towards a holistic understanding of the fluid-flow network's state and behavior. In some cases, a field device 110 deployed in a stormwater basin may include sensors for fluid level, turbidity, and chemical oxygen demand, while a device in a combined sewer may include flow velocity, hydrogen sulfide gas, and manhole lid position to detect surcharge or unauthorized access.

The field devices 110 may include sensors configured to monitor structural, environmental, or safety conditions. For example, a field device 110 may include a tilt sensor to detect manhole lid displacement, an accelerometer for vibration analysis, or a gas sensor for methane or hydrogen sulfide levels. These parameters may inform maintenance operations, detect unauthorized access, or signal safety-critical events independent of fluid-flow behavior. The fluid-flow control policy may include rules for evaluating and acting upon such non-hydraulic indicators.

The field devices 110 can be governed by a fluid-flow control policy that acts as a guiding framework for their operational behavior. Within the fluid-flow control policy, various parameters are managed, including but not limited to the monitoring frequency of field devices 110, the reporting frequency of field devices 110, and threshold criteria for the sensor data collected by field devices 110. By following the directives outlined in the fluid-flow control policy, the field devices 110 ensure consistent and efficient monitoring, data reporting, and adherence to predetermined threshold conditions. In some cases, the fluid-flow control policy explicitly defines an operational schedule that dictates how frequently each field device must transmit sensor data under different modes (e.g., every 1 minute in “storm mode,” every 10 minutes in “baseload mode.”) In some cases, the fluid-flow control policy includes a decision-making module that ingests environmental data (e.g., weather forecasts), historical event logs (e.g., past overflows), and system constraints (e.g., storage capacity, battery health), and outputs the designated mode and applicable operational criteria for each field device.

Threshold criteria for field devices 110 are described here as discrete values not to exceed for illustrative purposes but this is not intended to be limiting. The definition may be further expanded to include one or more parameters for algorithms that are executed on the field devices 110 to detect outliers, identify abnormal flow conditions, etc.

The sampling frequency for a field device 110 indicates the frequency at which the field device 110 performs continuous or periodic checks on the specified fluid-flow parameters. The monitoring frequency can be configured to align with the operational requirements and characteristics of the fluid-flow network transport infrastructure 100. For instance, the field devices 110 may conduct parameter sampling at predetermined intervals, such as X minutes (e.g., 1, 3, 5, 10) or Y hours (e.g., 1, 4, 8, 12, 24), ensuring a consistent stream of data without undue depletion of the device's power resources. The sampling frequencies of the field devices 110 can be individually configured or set for groups of devices. Monitoring frequency can also be specified and controlled for individual sensors within each device, following either a locally, remotely, or both local-and-remotely adjusted sampling schema. This flexibility allows for customized sampling intervals based on specific needs or network conditions within the fluid-flow network transport infrastructure 100. It also allows the field devices to intelligently prioritize the use of onboard or attached sensors based upon the fluid-flow state using a combination of local parameters, internal diagnostics, and information provided by the fluid-flow coordinator 120. As a result, different field devices 110 can operate with distinct sampling intervals, ensuring efficient and targeted data collection based on their designated monitoring requirements.

Each field device may monitor its parameter at a first, local monitoring frequency (e.g., every 30 seconds) using embedded diagnostics and environmental cues. However, it can report sensor data back to the coordinator at a second, lower reporting frequency (e.g., every 5 min) specified by the control policy. The local monitoring frequency can be autonomously adjustable by the field device based on internal diagnostics (e.g., battery level), environmental conditions (e.g., rising water levels), or triggers from the fluid-flow control policy.

In some configurations, a field device may include a lightweight proxy model configured to estimate expected water levels or other monitored parameters based at least in part on recent local trends, historical patterns, or compact statistical predictors. Such proxy models may include, but are not limited to, linear trend analyzers, autoregressive models, or embedded edge machine learning models trained on local datasets. These models may operate in the absence of cloud-based forecast data and/or may inform adaptive decisions regarding local monitoring frequency, alert generation, or transmission scheduling. In some cases, the proxy model may suppress data transmissions if current measurements satisfy (e.g., fall within) an expected confidence interval, thereby conserving communication and energy resources.

The reporting frequency indicates how frequently a field device 110 transmits the collected sensor data to, either directly or indirectly, the fluid-flow coordinator 120. The reporting frequency may vary among different field devices 110 within the network, as dictated by the fluid-flow control policy. By adhering to the reporting frequency, the field devices 110 contribute insights to the fluid-flow coordinator 120 while optimizing the utilization of their power usage.

In some cases, the field device 110 may incorporate a lightweight predictive module, such as a statistical trend analyzer or a compact edge-based machine learning model. These modules may forecast expected parameter ranges based at least in part on historical or recent local sensor data. This predictive capability can support local anomaly detection, threshold estimation, or alert generation without requiring synchronization with a remote fluid-flow coordinator 120 or simulated digital counterpart 140. In some cases, the predictive module may further operate based on additional inputs obtained from external data sources, such as environmental or operational metadata. This local forecasting capability may enhance the autonomy of the field device 110 and reduce dependency on upstream coordination or network availability.

In some cases, each field device is further configured to prioritize the transmission of summary metrics or event-based data over continuous raw sensor streams. For example, a field device may locally compute and report statistical aggregates (e.g., minimum, maximum, average, standard deviation) or pre-defined condition flags (e.g., overflow risk, rapid-rise events) in accordance with the fluid-flow control policy. The field device may retain high-resolution raw data locally and transmit such raw data only in response to a request from the fluid-flow coordinator or a remote administrative entity. This approach reduces bandwidth usage and energy consumption while preserving the ability to perform forensic or retrospective analysis upon demand.

The field devices 110 may apply local suppression logic to avoid redundant or low-priority transmissions. For example, if local sensor readings fall within an expected baseline range and exhibit minimal change over time, the field device 110 may delay or cancel a scheduled transmission. This behavior may be governed by confidence intervals, statistical deviation analysis, or preconfigured suppression rules in the fluid-flow control policy. Suppressed data may still be stored locally for retrospective analysis or transmission upon request.

The fluid-flow control policy can encompass threshold criteria for sensor data that establish specific levels or conditions of the monitored fluid-flow parameters that trigger the generation of an indication to the fluid-flow coordinator 120. Such indication may be in the form of an alert message, flag, or other communication indicative of a threshold being satisfied, exceeded, or deviated from. For example, if a field device 110 detects that a parameter value meets or exceeds a predetermined threshold set by the policy, the field device 110 can transmit an indication to the fluid-flow coordinator 120, supporting timely identification of potential issues or changes within the infrastructure. As an example, the control policy may define a dissolved oxygen threshold of below 3.0 mg/L as a low-oxygen alert, triggering enhanced sampling of water quality sensors and an alert to upstream contributors for potential industrial discharge.

During periods of inactivity or when not engaged in active communication (e.g., alerts) with the fluid-flow coordinator 120, the field devices 110 can operate in a low-power state. In this low-power state, the field devices 110 may monitor the respective parameters according to the monitoring frequency. If a threshold violation is identified during their monitoring cycles, the field device 110 “awakens” from the low-power state and transmits an alert signal to the fluid-flow coordinator 120. Thus, the field devices 110 can have the capability to locally monitor their respective parameters at a higher frequency than their scheduled reporting frequency. This enables them to gather data more frequently for local analysis and evaluation. In some embodiments, one or more field devices 110 may be configured to periodically transmit pre-aggregated or derived metrics, such as but not limited to maximum, minimum, average, standard deviation, or event flags, rather than full-resolution time-series data. This aggregation-based transmission model can reduce communication bandwidth and energy usage, while preserving operational insight. In some cases, this model may operate independently of threshold-based suppression strategies and may complement or replace periodic raw data reporting depending on the control policy. However, in the event of a detected event or when a predetermined threshold is exceeded, the field devices 110 can initiate an unscheduled data report, bypassing the regular reporting schedule. This can ensure that events (e.g., threshold violations) are promptly communicated to the fluid-flow coordinator 120, allowing for timely response and appropriate actions to maintain the integrity and efficiency of the fluid-flow network transport infrastructure 100.

In some cases, a field device 110 may transition from a first operational mode to a second operational mode based at least in part on sensor data, policy-defined thresholds, or received commands. For example, a first operational mode may correspond to a low-power monitoring state, while a second operational mode may correspond to an active communication or data transmission state. The transition may occur locally based on measured parameters or remotely in response to out-of-band commands from the fluid-flow coordinator 120. This flexible operational state model supports varied deployment conditions or dynamic adjustment of device behavior without requiring persistent communication.

In some cases, at least one operational mode may correspond to a diagnostic or self-test state. In this mode, the field device 110 may perform sensor calibration, battery health checks, wireless communication diagnostics, or actuator test cycles. Diagnostic modes may be scheduled periodically, triggered by anomalies, or invoked manually through the control system interface. Results from such diagnostics may be used to inform maintenance planning or update confidence metrics used in alert generation and policy execution.

During a period of inactivity, the field device 110 can be “awakened” from the low-power state by the fluid-flow coordinator 120. Thus, the field devices 110 can have the capability to adjust their operation based upon inputs from the fluid-flow coordinator 120 “out of band,” even if they are not scheduled to upload to or communicate with fluid-flow coordinator 120. This capability allows the fluid-flow coordinator 120 to access data and control one or more monitoring devices in a global fashion without the need to wait for devices to check-in.

In some instances, the fluid-flow control policy encompasses multiple operational modes that define specific rules governing the behavior of one, some, or all field devices 110. In some cases, each fluid-flow control policy is associated with a corresponding configuration of one or more of a monitoring frequency, a reporting frequency, alert thresholds, or activation logic. For example, a ‘dry mode’ may set a 10-minute monitoring interval with a 60-minute reporting interval, while a ‘flash flood mode’ may configure a 30-second monitoring interval and immediate reporting upon threshold breach. In some cases, the operational modes may treat individual field devices or groups of field devices differently from others. These operational modes include parameters such as the monitoring frequency of field devices 110, the reporting frequency of field devices 110, or threshold criteria for the sensor data collected by field devices 110. In some cases, an operational mode can be selected based on environmental data (e.g., meteorological data) to adapt to prevailing conditions within the fluid-flow network transport infrastructure 100. For example, during wet conditions or in anticipation of heavy rainfall, the fluid-flow control policy may indicate to the fluid-flow coordinator 120 to activate a first operational mode (e.g., a “wet mode”), which entails increased monitoring and reporting frequencies for field devices 110. Wet mode may be suitable for periods characterized by normal or heightened fluid-flow, often occurring during rainfall or other weather events. On the other hand, during dry conditions or expected periods of reduced flow, the fluid-flow control policy can indicate that the fluid-flow coordinator 120 trigger a second operational mode (e.g., a “dry mode”) that adjusts the monitoring and reporting frequencies to be less frequent. This adaptive approach of switching between operational modes can allow field devices 110 to conserve power (e.g., by monitoring or reporting less frequently) while still effectively monitoring for changes or threshold violations in the fluid-flow network transport infrastructure 100. It should be appreciated that the aforementioned first and second operational modes serve as illustrative examples, and the fluid-flow control policy may encompass a diverse range of operational modes or a spectrum thereof to accommodate varying network conditions and requirements. By selecting the appropriate operational mode (e.g., based on environmental data), the fluid-flow control policy can ensure that field devices 110 operate optimally, contributing to the overall efficiency and management of the system. In some cases, the policy may include a “flash flood mode,” activated when rainfall exceeds X (e.g., 0.5 inches) in Y (e.g., 30 minutes), prompting all field devices 110 in low-lying areas to switch to continuous monitoring at 30-second intervals.

The fluid-flow control policy may define a plurality of named or numeric operational modes, each specifying a profile for reporting frequency, alert thresholds, and/or control logic. Transitions between operational modes may be triggered by rule-based evaluations of environmental forecasts, observed hydraulic load, storage capacity, or inferred system state. In some cases, these transitions may be initiated autonomously at the field device level or propagated from the fluid-flow coordinator 120. Example transitions may include, but are not limited to, dry-to-wet switching, high-intensity event detection, or post-storm recovery behavior.

The fluid-flow coordinator 120 functions as a coordinating entity that facilitates communication and coordination among the field devices 110 and fluid-control devices 130 dispersed throughout the fluid-flow network transport infrastructure 100. Multiple instances of the fluid-flow coordinator 120 can be deployed across the infrastructure, each responsible for managing a subset of field devices 110 and/or fluid-control devices 130 within its designated area. The fluid-flow coordinators 120 can establish seamless communication with the field devices 110 and/or fluid-control devices 130 and maintain an up-to-date understanding of their distribution and interconnections. By leveraging the fluid-flow control policy, the fluid-flow coordinator 120 can configure and coordinate the operational modes of the field devices 110 under its purview, ensuring adherence to specific monitoring and reporting frequencies, as well as the threshold criteria for sensor data or algorithm adjustment for anomaly detection.

While presented here as distinct devices with unique functionality, it is possible that the functionality contained within a field device 110, a fluid-flow control device 130, and/or a fluid-flow coordinator 120 can be combined in a single device, where that device may provide more than one function. The function of the fluid-flow coordinator may also be provided by one or more services running on one or more distributed computing devices in the cloud.

In some configurations, coordination logic may be distributed among multiple entities, including but not limited to the fluid-flow coordinator 120, individual field devices 110, or external processing nodes. For example, multiple fluid-flow coordinators 120 may operate in parallel or in a federated manner, each managing a subset of field devices 110 or fluid-flow control devices 130. In some cases, coordination functionality may be implemented in a peer-to-peer structure across the field devices 110, based on their localized knowledge or policy instructions. This distributed configuration can support scalable operation, fault tolerance, or reduced latency.

The coordination architecture may support tiered or federated configurations. For example, the fluid-flow coordinators 120 may be arranged hierarchically (e.g., local, regional, central) to manage overlapping domains and synchronize policy decisions across the infrastructure. In some cases, the infrastructure can include a system of subnetworks, where each subnetwork includes a set of field devices managed by a local fluid-flow coordinator 120. These subnetworks can operate semi-independently and may coordinate with other subnetworks or higher-level coordinators to support broader system objectives. In some cases, field devices may participate in peer-to-peer coordination using decentralized communication frameworks, such as mesh networks or distributed consensus protocols. Such topologies can improve scalability, reduce control latency, or provide fault-tolerant operation during partial network outages.

In some implementations, subsets of field devices may be configured to operate as edge analytics clusters. Each cluster may coordinate local decision-making and inference tasks based on shared sensor inputs and peer-to-peer communication. The cluster may collaboratively evaluate flow conditions, generate distributed alerts, or initiate local control actions without requiring centralized coordination. In some cases, communication within the cluster can follow a star topology or subnetwork arrangement, where a local fluid-flow coordinator or hub device manages communication with a set of field devices. Such a decentralized architecture can improve responsiveness, reduce latency, and increase system resilience in scenarios where upstream connectivity is intermittent or delayed. In some cases, coordination among devices within a cluster may be governed by a lightweight consensus protocol or policy-defined decision framework.

In some examples, one or more field devices 110 may be configured to initiate communication with peer field devices 110 without routing the communication through the fluid-flow coordinator 120. For instance, a first field device 110 may determine that a local measurement satisfies a threshold condition and transmit a request, condition indicator, or sensor dataset to a second field device 110. In some implementations, coordination may occur among groups of field devices configured as an edge analytics cluster. These clusters may perform distributed inference based at least in part on locally shared measurements, enabling collaborative event detection, flow estimation, or preemptive control actions. Such as decentralized architecture may enhance robustness, responsiveness, or scalability, particularly in large-scale or partitioned fluid-flow networks. The receiving field device may respond by modifying its monitoring frequency, initiating a local action, or forwarding the information to the fluid-flow coordinator 120. Such peer coordination logic can reduce latency, improve resilience during connectivity interruptions, or support local decision-making in edge-deployed configurations. As an example, if a field device 110 near a stormwater inlet detects rising water levels and transmits a peer alert to a downstream device, the receiving device may begin preemptive sampling or trigger an automated valve to redirect flow.

In some configurations, a field device 110 may be configured to trigger activation of one or more peer field devices 110 based on locally detected threshold conditions and peer topology metadata. The activation may include transmission of a structured activation message over a local mesh network, enabling the receiving field device 110 to increase its reporting frequency, activate specific sensors, or initiate localized diagnostics. This decentralized activation behavior may occur independently of the fluid-flow coordinator 120.

The fluid-flow coordinator 120 can receive indications of alert conditions from the field device 110. Upon receiving indications of alert conditions from the field devices 110, the fluid-flow coordinator 120 can assume the responsibility of assessing and responding to these alerts. For example, the fluid-flow coordinator 120 can identify the specific field device that triggered the alert based on the received indications, indicating that the sensor data from that field device has satisfied the threshold for the designated mode. And the fluid-flow coordinator 120 can determine a set of field devices 110 that are hydrologically or hydraulically connected to the alerted field device and fall within a defined proximity threshold, for example utilizing the known network topology of the fluid-flow network transport infrastructure 100.

In response to the alert from a field device 110, the fluid-flow coordinator 120 can initiate a data readout command to the alerting field device. This command can prompt the field device 110 to transmit any number of sensor data that have not been uploaded prior to the alert. The fluid-flow coordinator 120, having received the sensor data can evaluate the dataset to validate the alert or otherwise provide further evaluation of the data in order to proceed. Similarly, the fluid-flow coordinator 120 may request that the field device 110 perform a number of confirmation measurements such as rapid succession in time or providing data from additional sensors to validate or invalidate the initial alert.

In some implementations, an alert from a field device 110 may be designated as provisional or unconfirmed, pending validation through secondary data sources. For example, the fluid-flow coordinator 120 may request rapid confirmation samples from the alerting device, issue peer-data requests to adjacent field devices, or evaluate model consistency through the simulated digital counterpart 140. In some such cases, only after confirmation may the system escalate the alert to trigger a physical control action or policy adjustment.

The fluid-flow coordinator 120 can initiate an activation command to each field device 110 of the identified set of field devices 110. This command can prompt the field devices 110 to transmit their respective sensor data to the fluid-flow coordinator 120. Alternatively, the field devices 110 can transmit their respective sensor data at the reporting frequency, as described herein. By collecting and analyzing the received sensor data, the fluid-flow coordinator 120 can gain insights into the current conditions and performance of the fluid-flow network transport infrastructure 100.

In some implementations, the activation command may include one or more configuration instructions, such as, but not limited to, a list of specific sensors to activate; an updated monitoring or reporting frequency; a localized threshold condition; or a conditional rule for generating secondary alerts. The activation command may be structured as a payload-compliant message (e.g., JSON, binary format) that is parsed by the field device's local controller to modify operational behavior in accordance with the control policy.

Based on the sensor data received from the field devices, the fluid-flow coordinator 120 can effectively manage the fluid-flow control devices 130 according to the fluid-flow control policy. For example, the fluid-flow coordinator 120 can apply the control criteria specified in the policy to regulate and optimize the operation of the fluid-flow control devices 130. This can include making adjustments to control settings, such as valve positions, pump speeds, or flow rates, to align with the desired operational objectives and maintain the integrity and efficiency of the fluid-flow network transport infrastructure 100.

The fluid-flow coordinator 120 can maintain a detailed understanding of the network topology encompassing the field devices 110. The topology can include a representation of the physical layout of the network, indicating the spatial arrangement of pipes, junctions, and the locations of the field devices. The topology can highlight or indicate the hydraulic connections and hydrological relationships between the field devices, reflecting drainage patterns, water flow directions, or catchment areas of the network. This topology may be provided via hydraulic and hydrologic models or through models that are digitally generated from the data (e.g. AI or ML models).

The fluid-flow coordinator 120 can obtain environmental data (e.g., meteorological data, exogenous data, etc.). The meteorological data can be indicative of impending weather conditions and can serve as an input for operations of the fluid-flow coordinator 120. By understanding the anticipated weather patterns, the fluid-flow coordinator 120 can make strategic decisions about managing fluid-flow within the network. The integration of meteorological data aids in anticipating changes in the fluid-flow, preventing potential overflows or shortages, and maintaining optimal operations. In some cases, if forecasted rainfall in a watershed area exceeds X (e.g., 2 inches) in Y (e.g., 2 hours), the fluid-flow coordinator 120 may trigger pre-emptive adjustments to control infrastructure (e.g., detention gate or valve position, pump speed) and initiate data collection from upstream and/or downstream flow monitors to verify inflow velocity.

In some embodiments, environmental data inputs such as precipitation forecasts are optional or omitted. Instead, the field devices 110 and the fluid-flow coordinator 120 may rely exclusively on local sensor data, internally maintained historical baselines, or observed real-time trends to determine operational modes or control actions. Such an approach may enhance applicability in deployments characterized by limited connectivity, lack of reliable forecast data, or constrained upstream bandwidth, and stands in contrast to systems that require exogenous environmental inputs to initiate model-based control.

The fluid-flow coordinator 120 can obtain data from treatment facilities such as wastewater treatment plants. The facility data can be used to estimate current treatment capacity and forecast capacity issues.

The fluid-flow coordinator 120 can obtain additional exogenous data, including but not limited to soil saturation, river levels, groundwater levels, tank or underground storage availability, land use, flood zones and topographic information, transport infrastructure utilization information such as vehicular traffic or rail transport information, as well as requirements such as minimum flows and levels for streams, maximum discharge temperatures or volume criteria, etc. from additional sources to inform and better direct the objectives of the control policy behavior.

By understanding the real-time or forecasted capacity of the fluid conveyance infrastructure, storage infrastructure, the wastewater treatment capacity, and other exogenous data, the fluid-flow coordinator has the information to provide control decisions that balance multiple objectives such risk of flooding of transport infrastructure, impact to water quality in receiving waters, risk of treatment plant washout, etc.

In some cases, the control logic executed by the fluid-flow coordinator 120 may be constrained by regulatory, environmental, or operational limits. These constraints may include, but are not limited to, minimum flow requirements for ecological health, limits on discharge temperature or pollutant concentration, energy consumption caps for active equipment, or compliance with treatment facility capacity thresholds. The fluid-flow control policy may encode these constraints as bounding parameters or soft objectives used to resolve competing priorities through weighted decision logic or optimization routines.

The fluid-flow coordinator 120 applies a fluid-flow control policy to adjust the operational mode of the field devices 110. The fluid-flow control policy outlines operational criteria for the field devices 110, as well as control criteria for managing fluid-flow control devices 130. This policy-driven approach facilitates adjustments to the operational mode of the devices, ensuring adaptability to the changing conditions in the fluid-flow network transport infrastructure 100.

The fluid-flow coordinator 120 can react proactively to any abnormalities within the system. When the fluid-flow coordinator 120 receives an alert from a field device 110 (e.g., indicating that sensor data satisfies a certain threshold), the fluid-flow coordinator 120 can identify other field devices that are hydrologically or hydraulically connected to the alerted device and are within a defined proximity. This can allow for a targeted response to specific network conditions, ensuring the issue is contained and managed efficiently. The fluid-flow coordinator 120 is responsible for transmitting an activation command to the hydrologically or hydraulically connected field devices 110, prompting them to transmit their sensor data. With this collective data, the fluid-flow coordinator 120 manages the fluid-flow control devices 130 according to the fluid-flow control policy. This management process can ensure that the fluid-flow network transport infrastructure 100 adapts based on real-time data, thereby enhancing the efficiency and effectiveness of the infrastructure.

The fluid-flow control devices 130 encompass a diverse range of equipment and mechanisms designed to regulate fluid-flow within the fluid-flow network transport infrastructure 100. Examples of these control devices include valves, pumps, flow regulators, and wastewater input controls, adjustable weirs, inflatable bladders, gates. Control devices may regulate the flow of fluid, create pressure differentials, or control the direction of flow. For example, valves play a role in controlling the flow rate and direction of fluid within the network by opening, closing, or adjusting their positions; pumps can provide pressure and energy to propel the fluid through the system; flow regulators can ensure a consistent flow rate by adjusting the flow velocity or restricting the flow as needed; and wastewater input controls can manage the entry of wastewater into the system, maintaining the balance and preventing potential overload. Bladders may be used to avail in-line storage opportunities. Weirs or gates may send flow to an above ground or below ground storage facility. Any number of control devices may also be used to send flow to a high rate treatment facility or to pass flow through an in-line chemical dosing system before discharge into a surface water. These fluid-flow control devices 130, along with their corresponding control settings dictated by the fluid-flow control policy, enable precise control and management of fluid-flow within the fluid-flow network transport infrastructure 100. For example, if a downstream sensor detects backflow due to a high tailwater condition, the fluid-flow coordinator 120 may close an upstream valve and activate a pump to redirect the flow to a secondary outfall or retention basin.

The simulated digital counterpart 140, also referred to as a digital twin, a model-based simulation engine, or a digital representation, can be configured to maintain a representation of the fluid-flow network transport infrastructure 100. This simulation component may operate as a standalone module, a distributed cloud service, or a hybrid execution layer across multiple platforms. The simulated digital counterpart 140 may incorporate topological, hydraulic, or operational characteristics of the infrastructure, either modeled explicitly (e.g., rule-based flow models) or implicitly (e.g., machine-learned relationships). The simulated digital counterpart 140 may be trained, configured, or updated using sensor data, operational telemetry, or historical patterns, and may reflect dynamic changes in system state. The simulated digital counterpart 140 can provide an intricate understanding of the operational conditions, fluid-flow dynamics, and system performance across various operational scenarios, facilitating data-informed management of the infrastructure. For example, the simulated digital counterpart 140 can be designed to replicate the behavior, dynamics, and performance of the physical infrastructure in its operational context. It can incorporate physical and operational characteristics of the fluid-flow network transport infrastructure 100, whether modeled explicitly or implicitly, including, but not limited to, the topology, the hydraulic and hydrological parameters, and the operational characteristics of the field devices 110 and fluid-flow control devices 130. In some cases, the simulated digital counterpart 140 can include a hydraulic simulation engine and/or a machine-learned surrogate model trained using historical rainfall, flow, and sensor data. In some cases, the digital counterpart 140 can simulate system states in regions lacking sensor coverage; identify unmeasured anomalies based on sensor-deviation patterns; and/or prioritize activation of additional field devices to resolve uncertainty or confirm predicted overflow events.

In some cases, field devices may operate independently of a digital twin, relying instead on internal state machines or simplified policy-driven logic to govern data transmission and local control behavior. This configuration enables functional autonomy in deployments characterized by limited upstream connectivity or intermittent communication availability. Additionally, the system architecture may support asymmetric deployment of modeling capabilities, wherein central coordination nodes maintain high-fidelity simulation engines while field devices implement lightweight predictive modules or none at all. This contrasts with symmetric architectures in which both centralized and field-level components require mirrored digital twin models.

A functionality of the simulated digital counterpart 140 can be to provide data infill, particularly during dry weather flow conditions. In situations where sensor data from the field devices 110 suggests low fluid levels, and the simulated digital counterpart 140 has a high confidence in these readings, the simulated digital counterpart 140 can fill data gaps, simulating a complete operational picture without requiring additional sensor data. This function can significantly conserve the battery life of the field devices 110. For example, during extended dry weather, the simulated digital counterpart 140 may suppress redundant data requests from field devices in confirmed low-activity zones, relying on modeled baseflow conditions to interpolate values between sparse sensor reports.

The simulated digital counterpart's 140 capacity for data infill can be complemented by an intelligent error correction mechanism. If the simulated digital counterpart 140 detects potential inaccuracies or anomalies, such as diffusion or dispersion in its model, it can activate the field devices 110 to transmit additional sensor data. This action allows the simulated digital counterpart 140 to validate its predictions, correct potential model errors, and enhance its understanding of the fluid-flow network transport infrastructure 100.

The field devices 110 can learn from the simulated digital counterpart 140. They can receive operational parameters that inform what should be a normal dry weather flow pattern, and use this information to identify anomalies or out-of-bound conditions in the infrastructure. This mutually beneficial learning process between the simulated digital counterpart 140 and the field devices 110 enhances the accuracy and reliability of the overall fluid-flow management system. In some cases, the simulated digital counterpart 140 may provide historical dry-weather flow signatures for a given segment, and if a field device 110 detects a deviation exceeding X (e.g., 20%), it may trigger a local diagnostic or peer-check sequence to verify abnormal behavior.

The simulated digital counterpart's 140 dynamic adaptability and predictive capabilities can play a role in the recursive updating of the fluid-flow control policy. By providing feedback on the effectiveness of the current policy settings and suggesting potential refinements, the simulated digital counterpart 140 can facilitate continual optimization of the fluid-flow control policy. This iterative learning process can enhance the overall performance, efficiency, and resilience of the fluid-flow network transport infrastructure 100.

In some configurations, the simulated digital counterpart 140 may trigger synthetic alerts, activation events, or control actions based on model-inferred fluid states in the absence of recent sensor confirmation. For example, during extended dry periods, the digital twin may infer rising inflow based on upstream rainfall and model predictions, and initiate activation of field devices or control settings to verify or preemptively respond to expected conditions. In these cases, the simulated digital counterpart 140 may provide a confidence score or uncertainty metric to guide whether inferred outputs should be acted upon directly or used for logging and future policy adjustments.

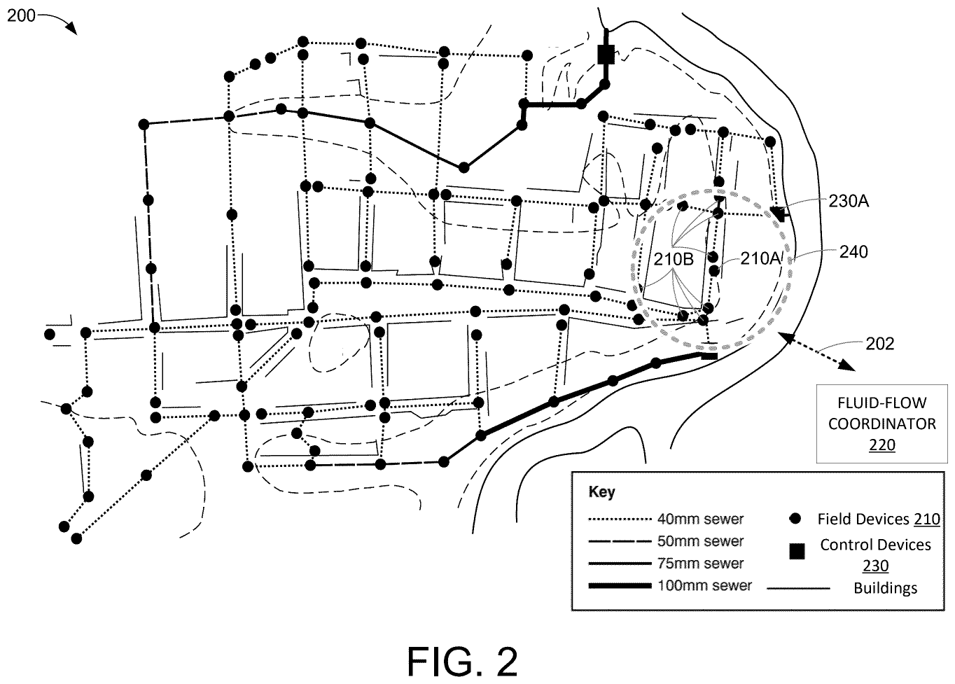

FIG. 2 illustrates a diagram of an example fluid-flow network transport infrastructure 200. The fluid-flow network transport infrastructure 200 represents a sewer layout, displaying a plurality of field devices 210 and control devices 230 positioned along sewer lines, as well as a fluid-flow coordinator 220 communicatively coupled via a network 202. The fluid-flow network transport infrastructure 200, the field devices 210, the fluid-flow coordinator 220, and the control devices 230 are embodiments of the fluid-flow network transport infrastructure 100, the field devices 110, the fluid-flow coordinator 120, and the control devices 130, respectively, of FIG. 1.

Consider a scenario in which a first field device 210A, located at a specific point in the fluid-flow network transport infrastructure 200, detects a deviation in the fluid-flow that exceeds a predetermined threshold. Upon detecting this condition, the first field device 210A transmits an alert signal to the fluid-flow coordinator 220. The fluid-flow coordinator 220, being informed of the alert, initiates an action to address the detected condition and ensure proper and efficient functioning of the fluid-flow network transport infrastructure 200.

In this example, the fluid-flow coordinator 220 utilizes its understanding of the network topology and connections to identify a set of field devices (collectively referred to a field devices 210B) that are hydrologically or hydraulically connected to the first field device 210 and are located within a defined proximity threshold 240.

Hydrological connectivity can broadly refer to any interconnectedness of field devices in terms of the flow of fluid within or outside of the fluid-flow network transport infrastructure 200 or within the watershed boundaries that may drain (directly or indirectly) into one or more segments of the fluid-flow network. Thus, field devices that are hydrologically connected may share a direct or indirect relationship in the movement of fluid. Hydrologic connectivity can be further determined by the drainage topography and built infrastructure that directs rain water into the fluid-flow pathways. For example, field devices that are hydrologically connected may be positioned along the same drainage path, interconnected through pipes, or have dependencies on each other for fluid-flow. Traditionally hydrologic controls may exist between and among stormwater control measures such as stormwater basins, retention and detention systems, ponds, engineered wetlands etc.

Hydraulic connectivity can broadly refer to any interconnectedness of field devices through the hydraulic properties and mechanisms within the fluid-flow network transport infrastructure 200. This connectivity can be determined by the physical layout of the sewer network, including the arrangement of pipes, junctions, and other fluid-flow pathways. Traditionally hydraulic controls would avail storage in sewer pipes, tanks, diversion structures, and storage tunnels, etc.

Field devices that are hydraulically or hydrologically (H&H) connected may be linked through the operation of valves, pumps, gates, weirs, dams, or other fluid-flow control devices. H&H connectivity is based on the functional interactions and dependencies between field devices within the infrastructure. While most of the exposition presented here is focused on sewer systems, they are an example of an urban drainage system which encompasses not only wastewater sewers or combined sewers but also storm sewers and multiple stormwater control measures such as those prior previously mentioned.

The proximity threshold 240 represents a policy-defined condition for determining whether a given field device is sufficiently related to a triggering field device to warrant further action. The proximity threshold 240 may be defined using one or more metrics, including physical distance (e.g., within 100 meters or 500 feet), topological separation (e.g., within three junctions or two pipe segments), or flow-path criteria (e.g., located within 500 meters downstream from the first field device 210). In some cases, proximity may also reflect hydraulic connectivity strength, flow travel time, or expected influence propagation distance. For example, the fluid-flow control policy may specify that, during dry weather conditions, a proximity threshold of within two pipe segments or 200 meters may apply, while during storm conditions, the proximity threshold may expand to within five junctions or 1000 meters downstream to account for higher flow velocities and longer propagation paths. Additionally, the proximity threshold 240 may be determined based at least in part on modeled relationships between field devices 210, such as shared drainage areas, inflow convergence zones, or anticipated response zones under dynamic conditions. In some cases, proximity thresholds may also be adjusted in real-time based on environmental inputs such as rainfall intensity, forecast duration, or basin saturation levels. For instance, during flash flood alerts, the proximity threshold may dynamically increase to include all devices within a 15-minute hydraulic travel time from the alerted device, as estimated by the simulated digital counterpart 140. The proximity threshold 240 may be statically configured, derived from network topology, or dynamically adjusted based on system conditions, environmental inputs, or outputs from the simulated digital counterpart 140.

The fluid-flow coordinator can evaluate a network topology that includes physical (e.g., pipe layouts, junctions) and/or logical (e.g., drainage relationships, flow paths) representations. Based on that representation, candidate field devices hydrologically or hydraulically connected to the first device are identified and then filtered according to a proximity threshold defined in the control policy. The proximity threshold may reflect hydraulic travel time (e.g., ≤15 min flow time), number of downstream junctions (e.g., ≤3), modeled flow propagation (e.g., expected reach within 500 m), or inferred influence zones derived from the simulated digital counterpart's modeling of fluid propagation.

Returning to the example scenario above, once the relevant set of field devices 210B is identified, the fluid-flow coordinator 220 transmits an activation command to these field devices 210B. This command prompts the field devices 210B to transmit their respective sensor data to the fluid-flow coordinator 220. Consequently, the field devices 210B comply with the command, enabling the fluid-flow coordinator 220 to gather comprehensive data from multiple points in the fluid-flow network transport infrastructure 200. In some cases, after initiating a first activation command, the fluid-flow coordinator continues to evaluate incoming sensor data and updates from flow models. If these updated conditions indicate that additional field devices now satisfy the proximity threshold—even if not originally activated—the coordinator can transmit a secondary activation command to those additional devices. This enables targeted data collection from newly relevant segments, improving situational awareness before commanding fluid-flow control actions. In some cases, each activation command sent to the selected field devices can include updated instructions, including adjustments to their reporting frequency (e.g., switch to 30-second intervals), enabling real-time data intensification during high-priority conditions.

Based on the sensor data from the first field device 210A and the set of field devices 210B and/or weather data, the fluid-flow coordinator 220 can effectively manage the operation of the control devices 230. By analyzing the received data and evaluating the system conditions, the fluid-flow coordinator 220 can make informed decisions to regulate the flow of fluid within the fluid-flow network transport infrastructure 200. For example, based on the collected sensor data, the fluid-flow coordinator 220 may adjust the control devices 230, such as opening or closing valves, adjusting pump speeds, or modifying flow rates, to maintain the desired fluid-flow and optimize the overall performance of the sewer system.

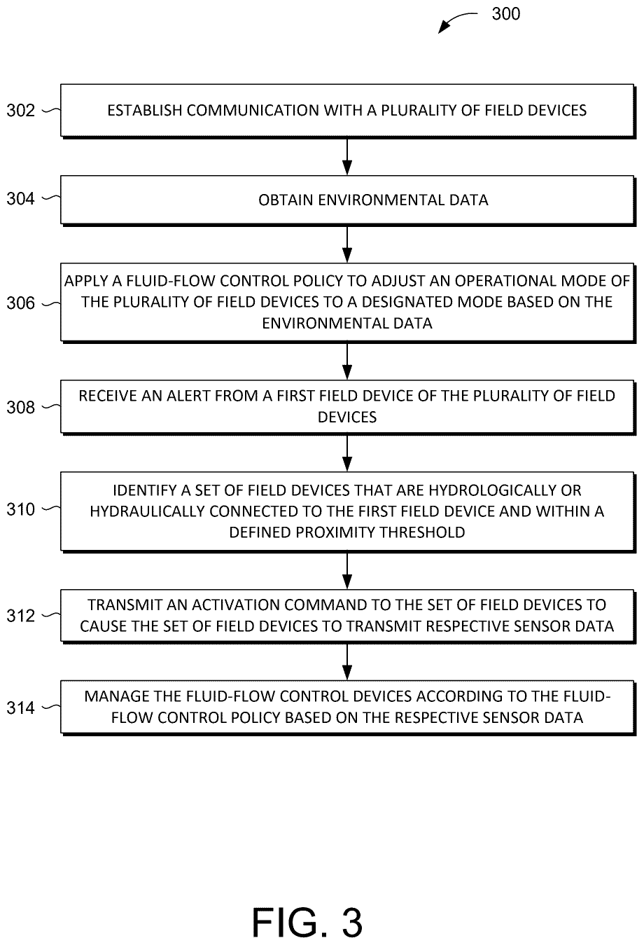

FIG. 3 is a flow diagram illustrating an example routine for controlling a fluid-flow network transport infrastructure. The elements depicted in the routine can be implemented using one or more computing devices associated with the fluid-flow coordinator 120. While the routine is logically associated with the fluid-flow coordinator 120, it should be noted that the following description is provided for illustrative purposes and is not intended to be limiting.

At block 302, the fluid-flow coordinator 120 establishes communication with a plurality of field devices within the fluid-flow network transport infrastructure. Each field device is equipped with a sensor that monitors a specific parameter related to fluid-flow. This communication enables the fluid-flow coordinator to receive sensor data from the field devices and exchange instructions or commands with them.

At block 304, the fluid-flow coordinator 120 obtains environmental data, such as meteorological data that provides information about prior, current, and/or impending weather conditions. This data can include factors such as, but not limited to, rainfall, temperature, humidity, or other relevant atmospheric conditions that can influence the behavior of the fluid-flow network. The exogenous data can include, but is not limited to, soil saturation, river levels, groundwater levels, tank or underground storage availability, land use, flood zones and topographic information, transport infrastructure utilization information such as vehicular traffic or rail transport information, as well as requirements such as minimum flows and levels for streams, maximum discharge temperatures or volume criteria, etc.

At block 306, the fluid-flow coordinator 120 applies a fluid-flow control policy to adjust the operational mode of the field devices. The control policy takes into account the environmental data and specifies the operational criteria for the field devices. It also includes control criteria for managing the fluid-flow control devices within the network. By adjusting the operational mode based on the control policy, the fluid-flow coordinator ensures that the field devices operate in a manner aligned with the prevailing network conditions and management objectives.

The fluid-flow control policy can indicate the frequency at which each field device should report sensor data. For instance, the policy might set that under normal conditions, the field devices send their collected data every hour. However, if a certain fluid-flow threshold is exceeded, triggering a “high-alert mode”, the policy may instruct the devices to send data every 10 minutes, ensuring real-time monitoring during potentially critical situations.

The fluid-flow control policy can indicate alert thresholds for the sensor data collected by field devices. For example, it could state that if a specific sewer line's flow rate surpasses 200 gallons per minute, the observing field device should immediately send an alert to the fluid-flow coordinator. This alert system allows for a swift reaction to possible issues within the fluid-flow network.

The fluid-flow control policy can indicate different operational modes for the field devices based on various conditions. For instance, in response to weather data predicting heavy rainfall, the policy may initiate a “storm mode”, where monitoring frequency increases and certain control devices adjust their settings to manage the anticipated increase in fluid-flow.

The fluid-flow control policy can indicate how the fluid-flow control devices should be managed based on the collected sensor data. In a specific scenario, if a field device reports an abnormally low fluid level in a reservoir, the policy might instruct the fluid-flow coordinator to increase the operating speed of the associated pump, maintaining the fluid supply.

The fluid-flow control policy can indicate the proximity threshold for determining other field devices that are affected by an alerted device. For example, if a field device sends an alert due to exceeding a specific fluid-flow parameter, the policy could instruct the fluid-flow coordinator to take into account other field devices within a 1000 feet radius or within 2 hydraulic points of connection, ensuring a comprehensive and targeted response to potential disruptions.

At block 308, the fluid-flow coordinator 120 receives an alert from a first field device among the plurality of field devices. In this example, the alert indicates that the sensor data from the first field device satisfies a threshold for the designated mode specified in the fluid-flow control policy. In this example, the alert serves as a trigger for further actions by the fluid-flow coordinator 120.

At block 310, leveraging the network topology of the field devices, the fluid-flow coordinator 120 identifies a set of field devices that are hydrologically or hydraulically connected to the first field device. The connection between these field devices and the first field device implies a direct or indirect relationship in terms of fluid-flow within the network. Additionally, the identified field devices fall within a defined proximity threshold, indicating their proximity to the first field device.

At block 312, the fluid-flow coordinator 120 transmits an activation command to the set of field devices identified in the previous step. This activation command instructs the field devices to transmit their respective sensor data to the fluid-flow coordinator. By doing so, the fluid-flow coordinator facilitates comprehensive data collection from the set of field devices, enabling a more accurate understanding of the network's current conditions and performance.

At block 314, based on the received sensor data and the fluid-flow control policy, the fluid-flow coordinator 120 manages the fluid-flow control devices within the network. This management involves making adjustments to control settings, such as valve positions, pump speeds, or flow rates, according to the specified control criteria in the fluid-flow control policy. By actively managing the fluid-flow control devices, the fluid-flow coordinator ensures that the fluid-flow network operates in accordance with the desired operational objectives and maintains its integrity and efficiency.

The arrangement of blocks depicted in FIG. 3 presents a versatile framework for controlling a fluid-flow network transport infrastructure. The implementation of these blocks allows for flexibility, such that the order and inclusion of specific blocks can be adjusted to meet varying operational requirements. For example, two or more of the blocks can be executed concurrently, enabling simultaneous processing of multiple tasks, or the blocks can be rearranged in a modified order to accommodate specific system configurations.

Moreover, the routine 300 is designed to accommodate different variations, such that fewer, more, or alternative blocks can be incorporated to suit the specific needs of the fluid-flow network. For example, blocks 302, 304, 306 may be removed. Furthermore, additional blocks may be used. For example, the fluid-flow control policy may be recursively updated, such as through the integration of machine learning algorithms, setting in motion a repeated process of optimization for the operation of the fluid-flow network transport infrastructure. This process can be iterative, fostering a dynamic cycle of data collection, analysis, policy alteration, and implementation.

The fluid-flow control policy can initially set the operational and control criteria for the field devices and control devices within the system. This initial policy dictates the system's responses to a variety of sensor readings and weather conditions. Concurrently, the machine learning algorithm can process and analyze sensor data from the field devices, meteorological data, and performance metrics from the network. Through the analyzed data, the machine learning algorithm can identify patterns, correlations, or anomalies, suggesting potential amendments to the fluid-flow control policy. These amendments can range from alterations to the alert thresholds or alert detection algorithms for certain field devices, to modifications of the proximity threshold used in identifying hydrologically connected devices, to changes in the control settings of fluid-flow control devices. These recommendations can be utilized to recursively update the fluid-flow control policy.

In some cases, one or more machine-learned models may be trained or deployed to support operations beyond policy adjustment. For example, a model may be configured to classify time-series sensor data, identify precursor indicators of threshold events, predict fluid-flow dynamics in unmeasured regions, or prioritize which field devices 110 should be activated for a given condition. These models may operate in real-time or near-real-time using edge processing or cloud-based resources. In some examples, the machine-learned models may also assist in scheduling maintenance operations, estimating system degradation, or proposing control actions. In some cases, the machine-learned model may be trained using historical rain-event response data to predict overflow risk zones with lead times of 15-30 minutes. For instance, a model may infer that rainfall above X (e.g., 1.2 inches) per hour in catchment A predicts CSO discharge from manhole M3 with 85% probability.

Following the update of the fluid-flow control policy, the revised operational and control criteria can be implemented within the system. This updated policy can influence the system's responses to sensor readings and weather conditions, potentially leading to improved efficiency and performance. As the system operates under this updated policy, the machine learning algorithm can continue to collect and analyze data, paving the way for future updates to the policy. This recursive cycle of policy implementation, data analysis, and policy updating allows the fluid-flow control policy to dynamically evolve in response to changing conditions and performance objectives

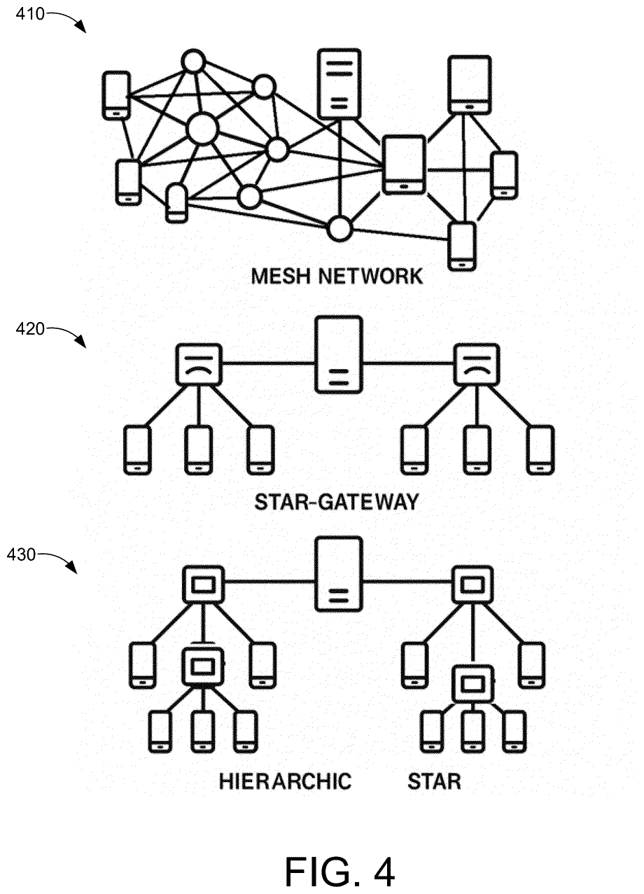

FIG. 4 illustrates example communication topologies for coordinating field devices in a fluid-flow network transport infrastructure, such as the fluid-flow network transport infrastructure 100 of FIG. 1. The illustrated topologies include a mesh network topology 410, a star-gateway topology 420, and a hierarchic star topology 430, any of which may be used individually or in combination to support data exchange, control coordination, and/or policy execution among field devices 110 and fluid-flow coordinators 120.

The mesh network topology 410 can include a set of field devices 110 configured to communicate directly with one another in a peer-to-peer arrangement. This configuration can support distributed coordination, localized inference, and/or redundancy in communication paths, which can improve system resilience during connectivity interruptions.

The star-gateway topology 420 can include one or more gateway nodes, such as localized fluid-flow coordinators 120, communicatively coupled to a set of field devices 110 in a star arrangement. Each gateway node can manage communication, control actions, and/or data reporting for its associated devices, enabling localized operation within a broader system.

The hierarchic star topology 430 can represent a multi-tiered architecture in which multiple subnetworks of field devices 110 are each managed by local coordination nodes, and the local coordination nodes are in turn connected to higher-level coordination entities. This hierarchical configuration can allow for scalable and federated control, where each subnetwork operates semi-independently while contributing to global system behavior.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for controlling a fluid-flow network transport infrastructure, the method comprising:
establishing communication with a plurality of field devices, wherein each field device comprises a sensor configured to monitor a parameter related to fluid-flow within the fluid-flow network transport infrastructure;
obtaining environmental data associated with the fluid-flow network transport infrastructure;
applying a fluid-flow control policy to adjust an operational mode of the plurality of field devices to a designated mode based at least in part on the environmental data, wherein the fluid-flow control policy comprises operational criteria for the plurality of field devices and control criteria for managing one or more fluid-flow control devices based on modeled or real-time system conditions;
receiving an alert from a first field device of the plurality of field devices, wherein the alert indicates that sensor data from the first field device satisfies a threshold associated with the designated mode;
identifying, based on a network topology of the plurality of field devices, a set of field devices that are hydrologically or hydraulically connected to the first field device and satisfy a defined proximity threshold, wherein the defined proximity threshold is based at least in part on flow path characteristics, topological separation, or modeled influence zones;
transmitting an activation command to the set of field devices to cause the set of field devices to transmit respective sensor data; and
managing the one or more fluid-flow control devices according to the fluid-flow control policy based on the respective sensor data.

2. The method of claim 1, wherein identifying the set of field devices comprises:
evaluating the network topology using a representation of physical and logical infrastructure relationships to determine candidate field devices that are hydrologically or hydraulically connected to the first field device; and
selecting the set of field devices based at least in part on the defined proximity threshold specified in the fluid-flow control policy, wherein the defined proximity threshold reflects one or more of hydraulic travel time, number of downstream junctions, modeled flow propagation, or inferred influence regions from a simulated digital counterpart.

3. The method of claim 1, wherein each field device of the plurality of field devices is configured to monitor the parameter at a first monitoring frequency and report the sensor data at a second reporting frequency that is lower than the first monitoring frequency, and wherein the first monitoring frequency is adjusted locally by the field device based on internal diagnostics, environmental conditions, or policy-defined operational criteria.

4. The method of claim 1, further comprising:
in response to receiving the alert and activating the set of field devices, determining that one or more additional field devices not included in the set also satisfy the defined proximity threshold based on updated sensor data or flow modeling; and
transmitting a secondary activation command to the one or more additional field devices to obtain further sensor data for use in managing the fluid-flow control devices.

5. The method of claim 1, wherein the fluid-flow control policy indicates an operational schedule for the plurality of field devices, wherein the operational schedule specifies a frequency at which the plurality of field devices transmit sensor data.

6. The method of claim 1, wherein each field device of the plurality of field devices communicates sensor data at a frequency defined by the fluid-flow control policy and locally monitors the respective parameter at a more frequent frequency.

7. The method of claim 1, wherein the fluid-flow control policy includes a policy-driven decision-making module that determines the designated mode and the operational criteria for the plurality of field devices based on the environmental data, historical data, or system constraints.

8. The method of claim 1, wherein the fluid-flow control policy includes a machine learning algorithm that continuously adapts and optimizes the operational mode and control criteria for the plurality of field devices based on observed system behavior and performance.

9. The method of claim 1, further comprising:
inputting the sensor data received from the plurality of field devices into a trained machine-learned model configured to analyze the sensor data and generate one or more policy adjustment outputs, wherein the policy adjustment outputs modify the fluid-flow control policy by adjusting at least one of the operational criteria for the plurality of field devices, threshold conditions for alert generation, control settings for fluid-flow control devices, or reporting frequency of the sensor data; and
applying the modified fluid-flow control policy to dynamically regulate fluid-flow within the fluid-flow network transport infrastructure based at least in part on the policy adjustment outputs.

10. The method of claim 1, wherein each field device includes a lightweight predictive model selected from a statistical trend analyzer or an edge-deployed machine-learned model, the predictive model configured to forecast expected parameter values based on local sensor history and to generate alert indications independent of the simulated digital counterpart.

11. The method of claim 1, wherein each field device is configured to transmit pre-aggregated sensor data comprising one or more of: a maximum value, a minimum value, an average, a statistical variance, or an event flag indicating a threshold condition during a defined aggregation interval.

12. The method of claim 1, wherein the alert from the first field device is generated based on a locally executed anomaly detection model configured to identify deviations from a forecasted parameter envelope.

13. The method of claim 1, wherein the proximity threshold is dynamically adjusted based at least in part on environmental data, hydraulic travel time estimates, or system condition forecasts generated by the simulated digital counterpart.

14. The method of claim 1, wherein the operational mode of the plurality of field devices is selected based at least in part on sensor data collected from the field devices, internal historical baselines, or system diagnostics, and without reliance on external meteorological forecasts.

15. The method of claim 1, wherein a subset of the plurality of field devices are configured to operate as a decentralized edge analytics cluster, the edge analytics cluster being configured to exchange local sensor data and collaboratively initiate control actions or alert generation based at least in part on coordination with a localized instance of the control system associated with the cluster.

16. A system for controlling a fluid-flow network transport infrastructure, the system comprising:
a control system comprising one or more processors and memory storing instructions that, when executed by the one or more processors, cause the control system to:
establish communication with a plurality of field devices, each field device comprising at least one sensor configured to monitor a parameter related to fluid-flow within the fluid-flow network transport infrastructure and a communication interface configured to transmit sensor data;
obtain environmental data associated with the fluid-flow network transport infrastructure;
apply a fluid-flow control policy to adjust an operational mode of the plurality of field devices to a designated mode based at least in part on the environmental data, wherein the fluid-flow control policy comprises operational criteria for the plurality of field devices and control criteria for managing one or more fluid-flow control devices based on modeled or real-time system conditions, wherein the one or more fluid-flow control devices are configured to regulate fluid-flow within the fluid-flow network transport infrastructure;
receive an alert from a first field device of the plurality of field devices, wherein the alert indicates that sensor data from the first field device satisfies a threshold associated with the designated mode;
identify, based on a network topology of the plurality of field devices, a set of field devices that are hydrologically or hydraulically connected to the first field device and satisfy a defined proximity threshold, wherein the defined proximity threshold is based at least in part on flow path characteristics, topological separation, or modeled influence zones;
transmit an activation command to the set of field devices to cause the set of field devices to transmit respective sensor data; and
manage the one or more fluid-flow control devices according to the fluid-flow control policy based on the respective sensor data.

17. The system of claim 1, wherein the control system is further configured to identify the set of field devices by evaluating the network topology using a representation of physical and logical infrastructure relationships to determine candidate field devices that are hydrologically or hydraulically connected to the first field device, and selecting the set of field devices based at least in part on the defined proximity threshold specified in the fluid-flow control policy, wherein the defined proximity threshold reflects one or more of hydraulic travel time, number of downstream junctions, modeled flow propagation, or inferred influence regions from a simulated digital counterpart.

18. The system of claim 1, wherein each field device is further configured to monitor the parameter at a first monitoring frequency and report the sensor data at a second reporting frequency that is lower than the first monitoring frequency, and wherein the first monitoring frequency is locally adjusted by the field device based on internal diagnostics, environmental conditions, or policy-defined operational criteria.

19. The system of claim 1, wherein the control system is further configured to, in response to receiving the alert and activating the set of field devices, determine that one or more additional field devices not included in the set also satisfy the defined proximity threshold based on updated sensor data or flow modeling, and transmit a secondary activation command to the one or more additional field devices to obtain additional sensor data for use in managing the one or more fluid-flow control devices.

20. A non-transitory computer-readable medium storing instructions that, when executed by one or more processors of a control system, cause the control system to perform operations comprising:
establishing communication with a plurality of field devices, wherein each field device comprises a sensor configured to monitor a parameter related to fluid-flow within the fluid-flow network transport infrastructure;
obtaining environmental data associated with the fluid-flow network transport infrastructure;
applying a fluid-flow control policy to adjust an operational mode of the plurality of field devices to a designated mode based at least in part on the environmental data, wherein the fluid-flow control policy comprises operational criteria for the plurality of field devices and control criteria for managing one or more fluid-flow control devices based on modeled or real-time system conditions;
receiving an alert from a first field device of the plurality of field devices, wherein the alert indicates that sensor data from the first field device satisfies a threshold associated with the designated mode;
identifying, based on a network topology of the plurality of field devices, a set of field devices that are hydrologically or hydraulically connected to the first field device and satisfy a defined proximity threshold, wherein the defined proximity threshold is based at least in part on flow path characteristics, topological separation, or modeled influence zones;
transmitting an activation command to the set of field devices to cause the set of field devices to transmit respective sensor data; and
managing the one or more fluid-flow control devices according to the fluid-flow control policy based on the respective sensor data.
